(19) United States
(12) Patent Application Publication
(10) Pub. No.: US 2005/0116720 A1
(43) Pub. Date: Jun. 2, 2005

(54) Method to detect and determine bearing to a rocket launch or muzzle blast

(76) Inventors: Paul A. Zank, Brookline, NH (US); Eldon M. Sutphin, Merrimack, NH (US); David W. Buchanan, Brookline, NH (US)

Correspondence Address: BAE SYSTEMS INFORMATION AND;ELECTRONIC SYSTEMS INTEGRATION INC., 65 SPIT BROOK ROAD, P.O. BOX 868 NHQ1-719, NASHUA, NH, 03061-0868, US

(21) Appl. No.: 10/917,793

(22) Filed: Aug. 12, 2004

Related U.S. Application Data
(63) Continuation-in-part of application No. 10/315,561, filed on Dec. 10, 2002.
(60) Provisional application No. 60/356,557, filed on Feb. 12, 2002.
(60) Provisional application No. 60/416,146, filed on Oct. 4, 2002.

(30) Foreign Application Priority Data
Feb. 13, 2003 (WO) PCT/US03/04092

(51) Int. Cl. G06F 9/45

(52) U.S. Cl. 324/451; 102/347

(57) ABSTRACT

A method of detecting and determining the bearing of a rocket launch or muzzle blast. First a plurality of spaced electrical field sensors is provided. Then distortions of the electrical field at each of said sensors are measured.

### CROSS REFERENCE TO RELATED APPLICATIONS

This application is a continuation-in-part of U.S. application Ser. No. PCT/US2003/004092. This application also claims rights under U.S. application Ser. No. 60/356,557, filed Feb. 12, 2002; U.S. application Ser. No. 60/256,812, filed Sep. 24, 2002; U.S. application Ser. No. 60/416,146 filed Oct. 4, 2002; and U.S. application Ser. No. 10/315,561, filed Dec. 10,2002, the contents each of which is incorporated herein by reference.

### BACKGROUND OF THE INVENTION

1. Field of the Invention

The present invention relates to measuring electricity. More particularly the present invention relates to measuring electrical fields to detect the launching of ballistic missiles or other rockets or muzzle blasts and to determine the bearing of such launch or muzzle blast.

2. Brief Description of Prior Developments

The prior art discloses a number of ways of detecting the launch of ballistic missiles or other rockets. One such way is radar. Radar, however has a number of disadvantages in that it is an active system and may easily be detected and jammed.

Another method of detecting the launch of a ballistic missile is orbital IR. Such systems however also have disadvantages in that they are ordinarily not effective until the missile has climbed out of the lower atmosphere.

Another disadvantage of both radar and/or orbital IR systems is that both of these systems tend to be extremely expensive.

A need, therefore, exists for a system which overcomes the disadvantages of the prior art.

### SUMMARY OF INVENTION

The present invention is a method of detecting and determining the bearing of a rocket launch or muzzle blast comprising the steps of first providing a plurality of spaced electrical field sensors then measuring distortions of the electrical field at each of said sensors.

A suitable sensor for use in the method of the present invention is disclosed in the aforesaid U.S. patent application Ser. No. 10/315,561, filed Dec. 10, 2002.

### DETAILED DESCRIPTION OF THE PREFERRED EMBODIMENTS

The present invention is further described with reference to the accompanying drawings wherein:

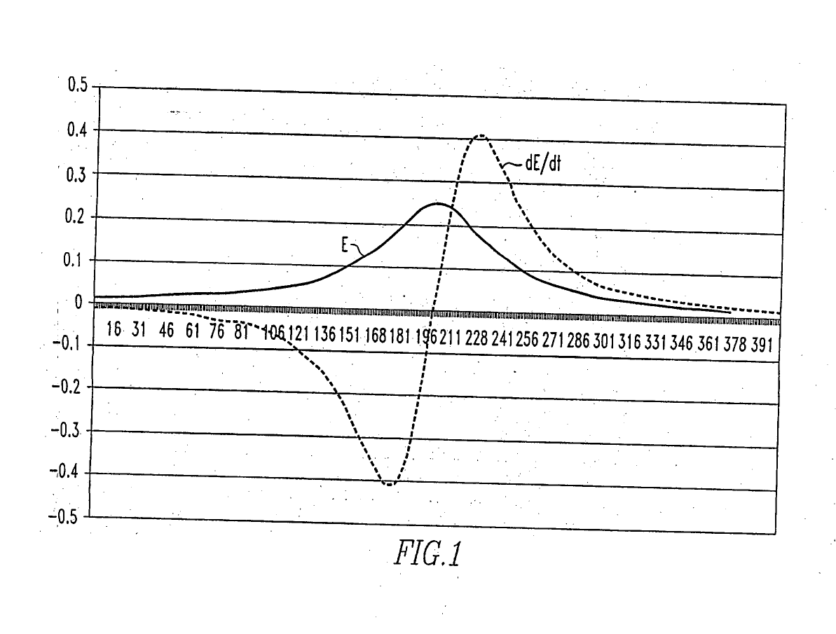

FIG. 1 is a graph showing E and a corresponding dE/dt by time;

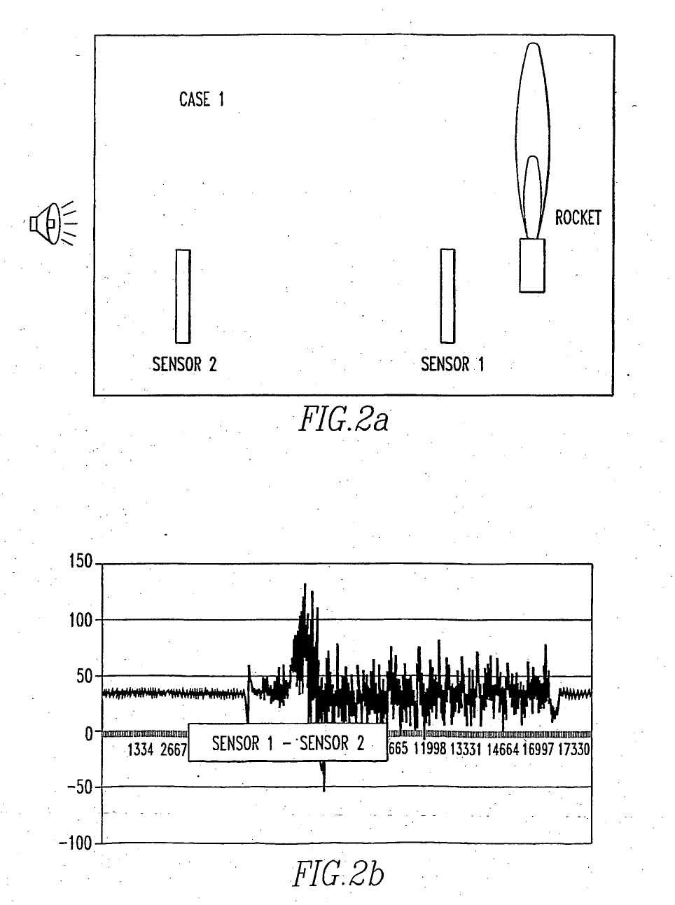

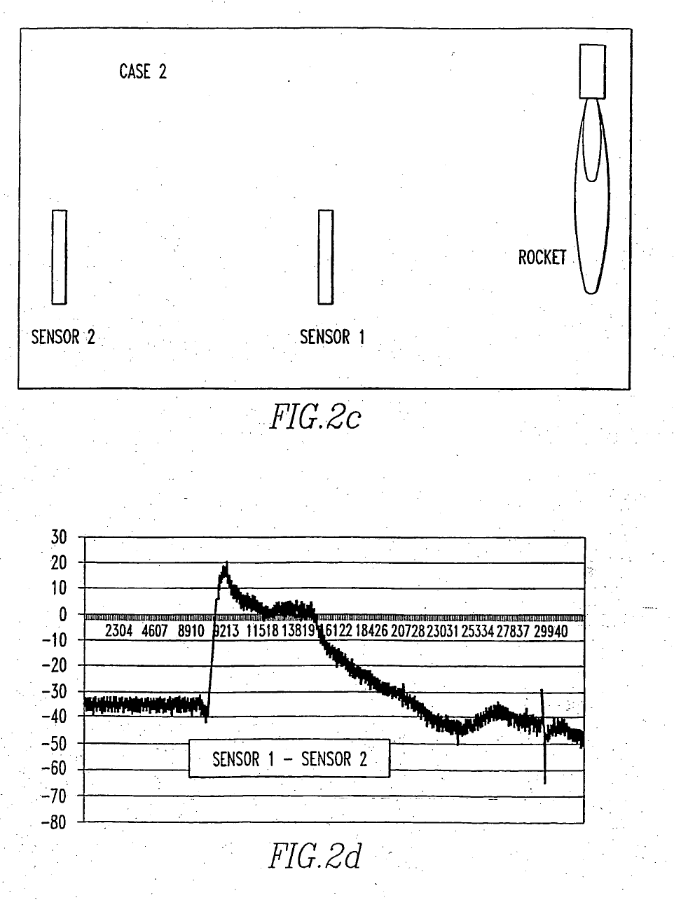

FIG. 2a-2d show schematic drawings of rocket launches and graphs showing dE/dt;

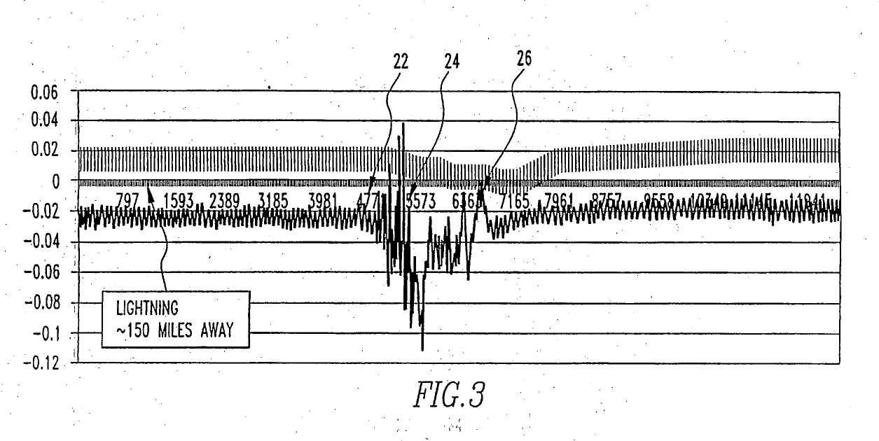

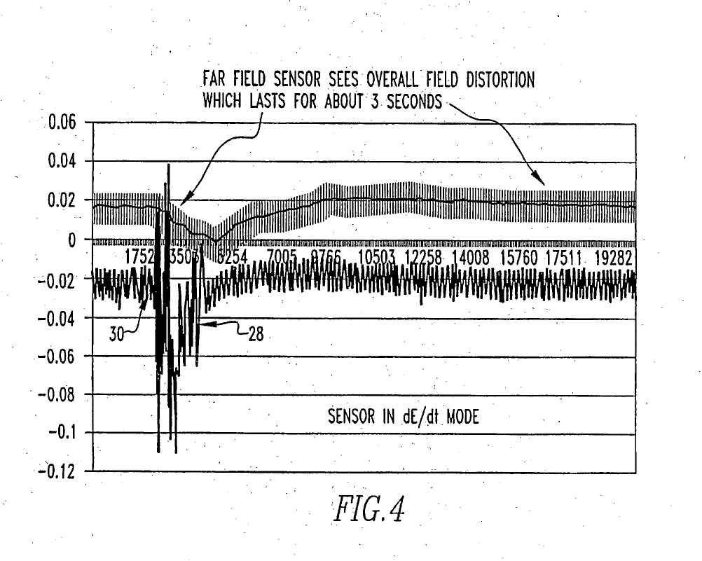

FIGS. 3 and 4 show the results of the distortion of E field resulting from a rocket in flight;

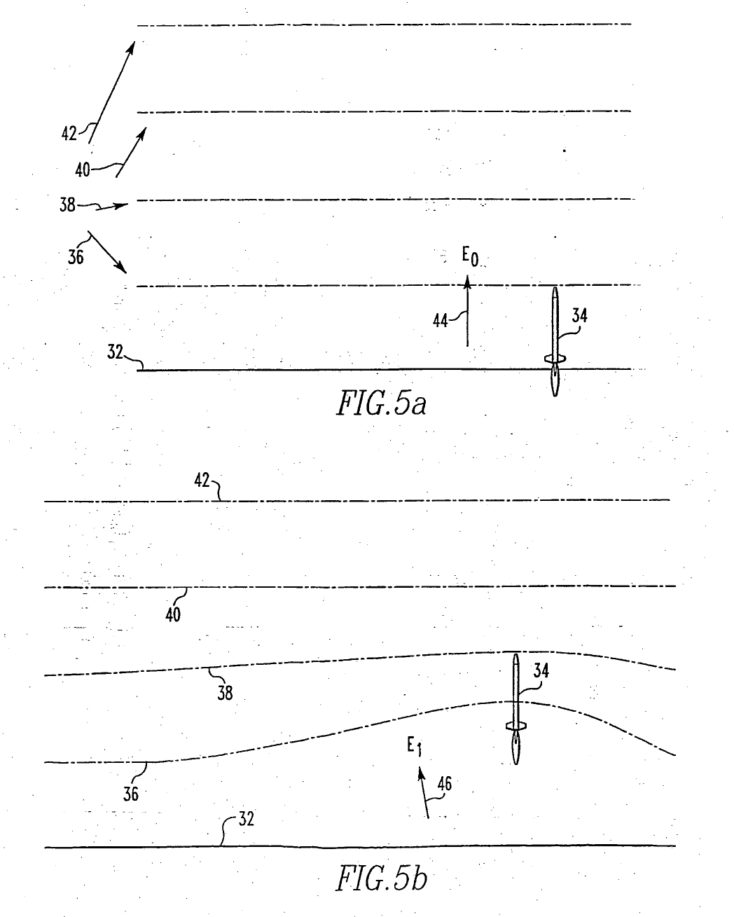

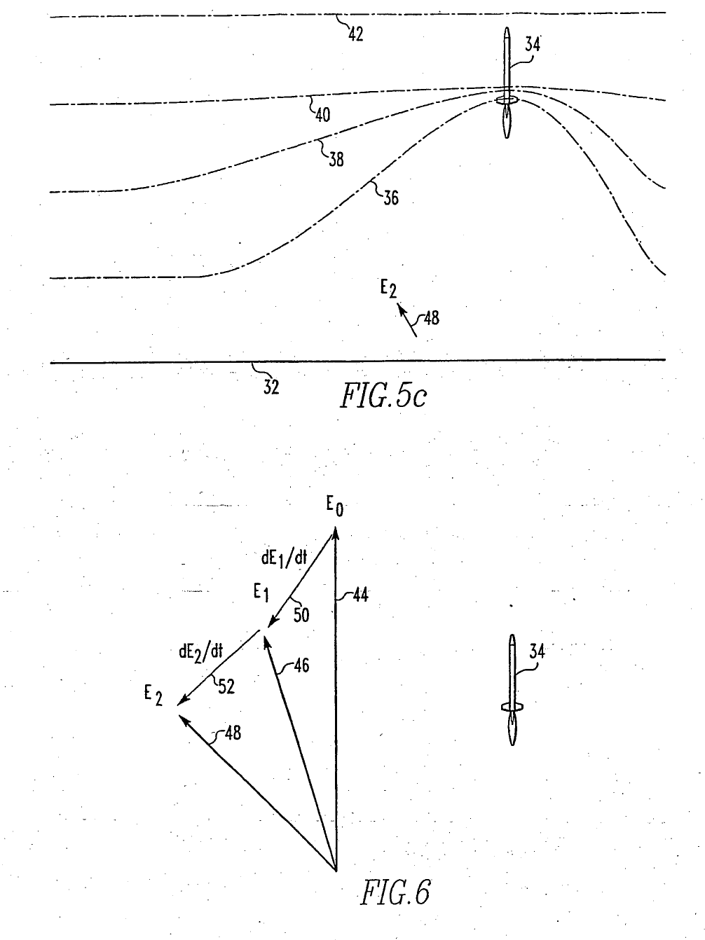

FIGS. 5a-5c show successive stages in the distortion in the E field resulting from the launch of a rocket;

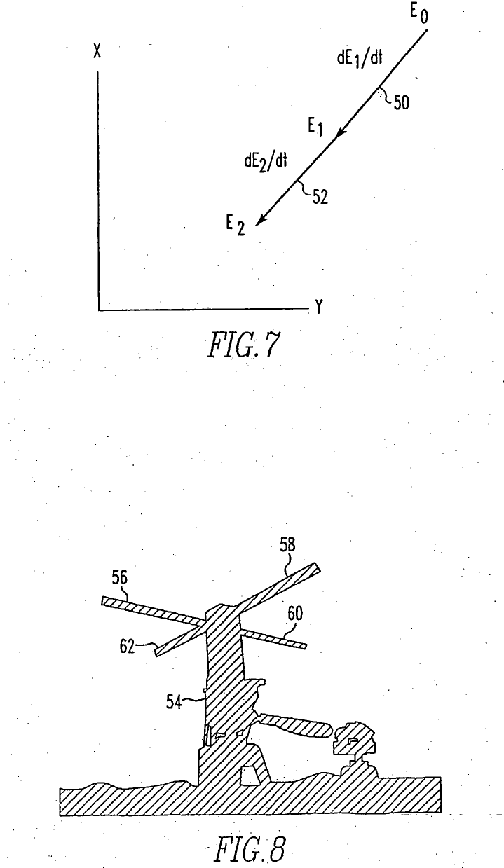

FIG. 6 is a side view showing vectors of E and dE/dt corresponding to FIGS. 5a, 5b and 5c;

FIG. 7 is a top view of vectors showing dE/dt corresponding to FIGS. 5a, 5b and 5c;

FIG. 8 is a perspective view showing a sensor and an antenna arrangement so that a two axis differential sensor is established;

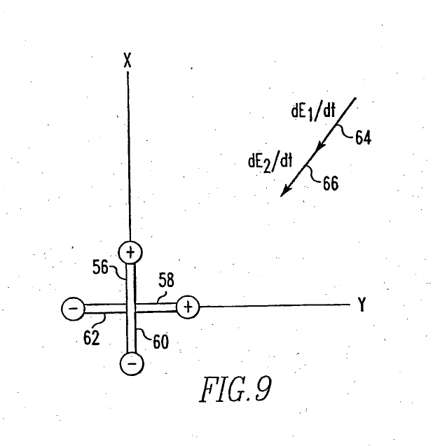

FIG. 9 is a perspective view showing vectors for dE/dt for the sensor and antenna arrangement shown in FIG. 8

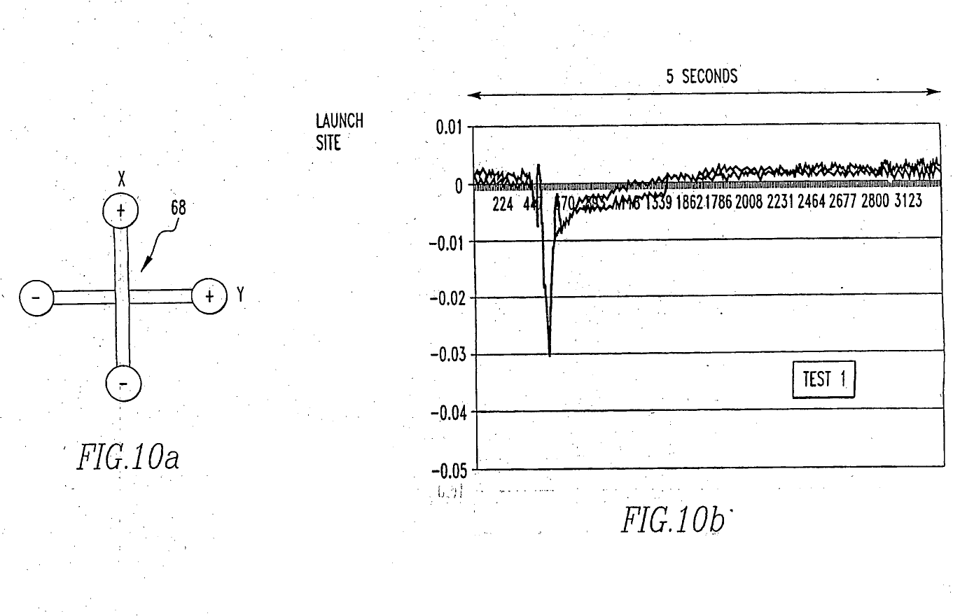

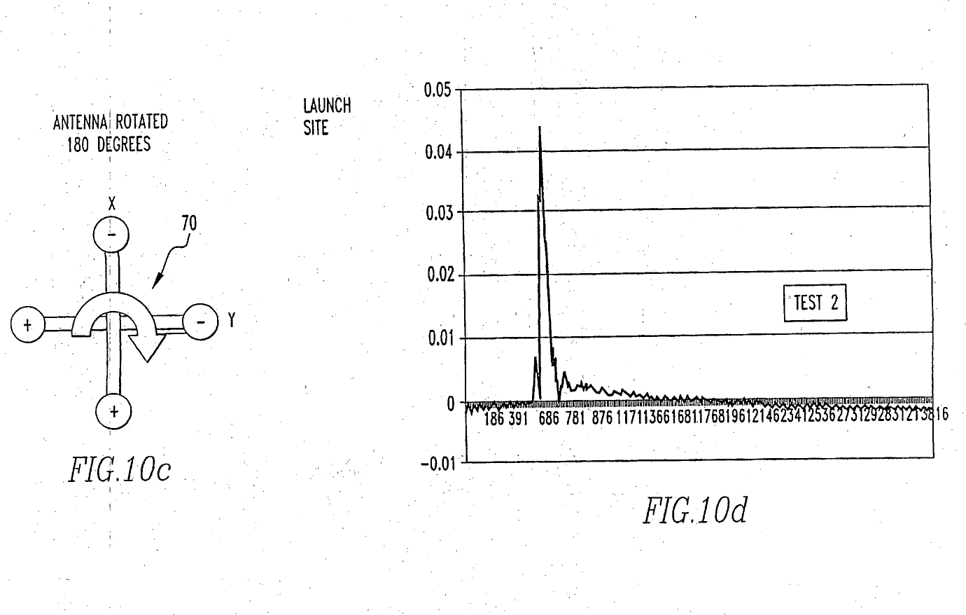

FIG. 10 is a graph of dE/dt for the two axis arrangement shown in FIG. 19.

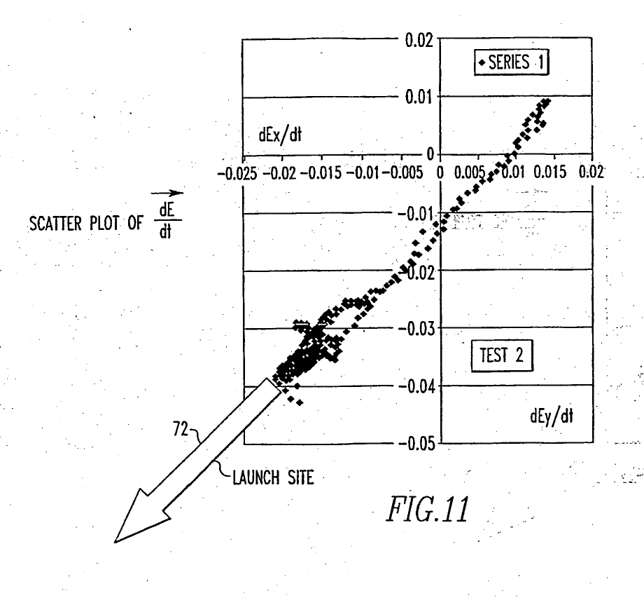

FIG. 11 is a graph showing a scatter plot of dE/dt.

FIG. 12 is a graph showing the detection of a muzzle blast by means of changes in E field;

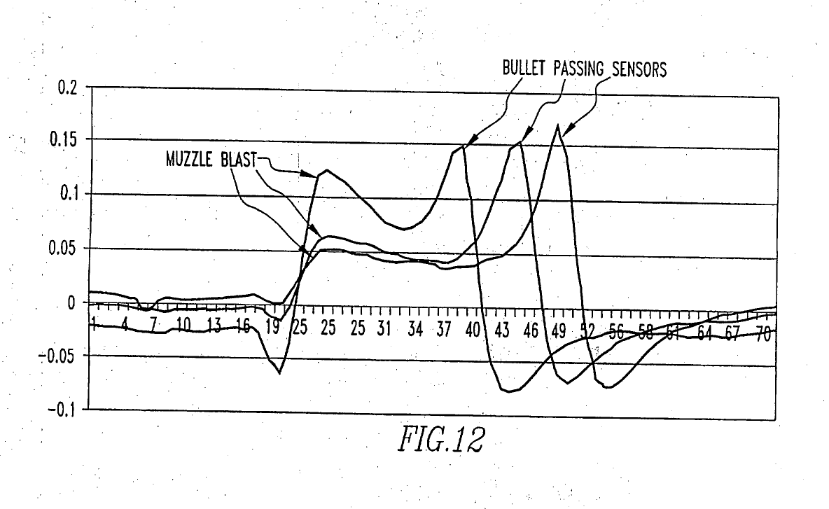

FIG. 13 is another a graph showing changes in E field by means of a muzzle blast;

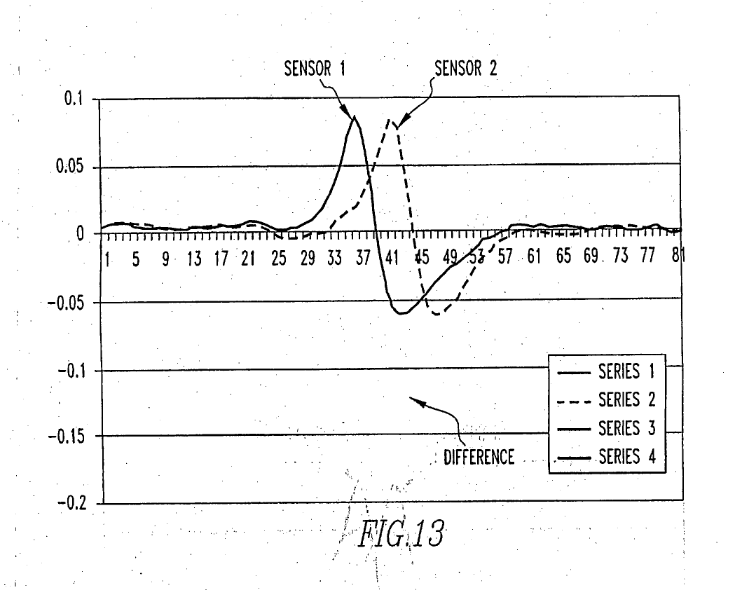

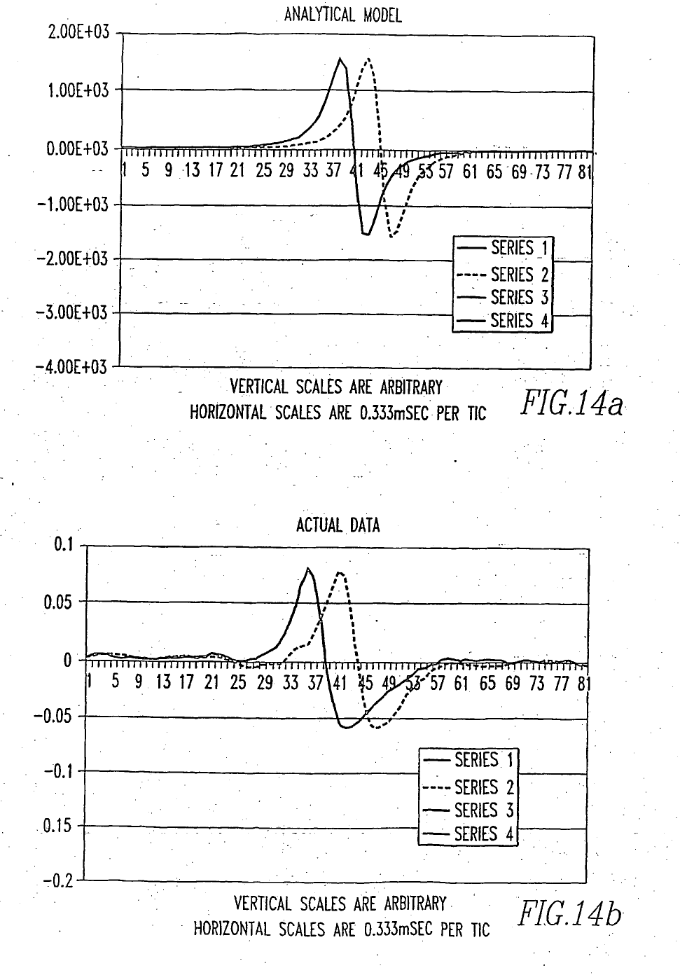

FIGS. 14a and 14b are respectively an analytical model and actual data showing the detection of a muzzle blast by changes in E field; and

FIG. 15 is a graph showing changes in E as a bullet passes sensors.

### DETAILED DESCRIPTION OF THE PREFERRED EMBODIMENTS

Referring to FIG. 1, it will be seen that the advantage of measuring dE/dt as compared to E is that it eliminates drift problems and it allows the observer to see small AC changes in large DC fields. It also allows some measurements, such as closest approach to be a zero crossing detection measurement as opposed to an estimate of maximum. Those skilled in the art will appreciate that it is often difficult to precisely measure such maximums.

Referring to FIG. 2a-2d in case 1 there is a sensor 10 and a sensor 12 with a rocket 14 oriented in one direction. In case 2 there is a sensor 16 and a sensor 18 oriented in another direction. In case 1 the change in E field by time is shown by time in which a rocket engine with exhaust pointing upward is used adjacent to two sensors. In case 2 E field change by time is shown adjacent to sensors in which the rocket engine points downwardly.

Referring to FIG. 3 the position on the graph on ignition is shown at 22, the position at about 200 feet is shown at 24 and the position of burn out is shown at 26.

Referring to FIG. 4, the position of the rocket at about two feet is shown at point 28. The position of the rocket at 400 feet as is shown at point 30.

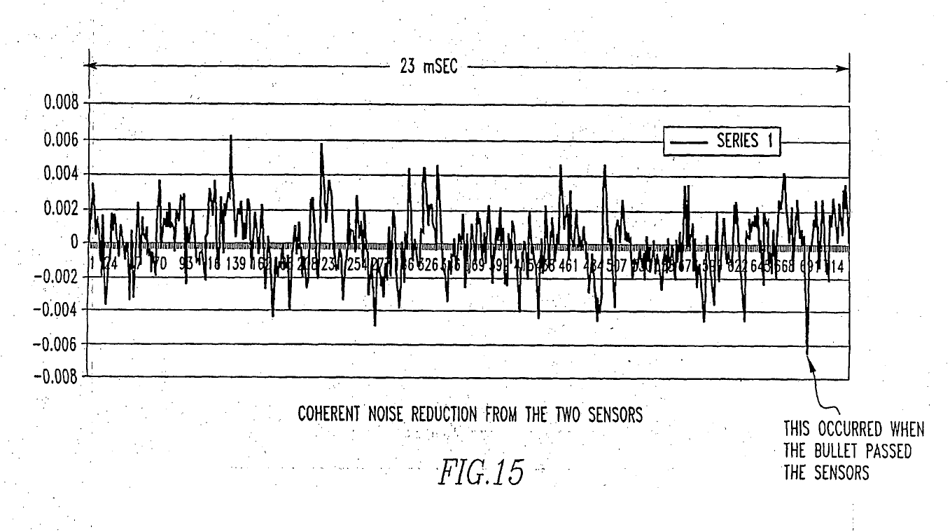

Referring to FIGS. 5a-5c, the surface 32 from which a rocket 34 is launched is shown. Isopotential lines are shown at 36, 38, 40 and 42. The Eo vector is at 44 (FIG. 16a). The E1 vector is at 46 (FIG. 16b). The E2 vector is at 48 (FIG. 16c).

Referring to FIG. 6, a vector side view of the arrangement shown in FIGS. 5a-5c is shown in which the rocket is shown at 34 and vector Eo is shown at 44, vector E1 is shown at 46, and vector E2 is shown at 48. Vector dE1/dt is shown at 50, and vector dE2/dt is shown at 52.

Referring to FIG. 7, a vector top view is shown wherein vector dE1/dt is shown at 50 and vector dE2/dt is shown at 52.

Referring to FIG. 8, an antenna for use in the method of the present invention is shown which includes a central vertical support 54 and horizontal perpendicularly arranged arms 56, 58, 60 and 62. A suitable sensor may be positioned on the vertical support 54.

Referring to FIG. 9, the antenna with perpendicularly arranged arms 56, 58, 60 and 62 is positioned so that arms 56 and 58 respectively are positioned on an x and a y axis so that vectors dE1/dt and dE2/dt are positioned between the x axis and y axis.

Referring to FIGS. 10a and 10b, in a test 1 antenna 68 is positioned to produce the graph shown in FIG. 10b.

Referring to FIGS. 10c and 10d, in a test 2 antenna 70 is rotated 180 degrees relative to antenna 68 to produce the graph shown in FIG. 10d.

Referring to FIG. 11, a scatter plot of dE/dt from test 2 is shown which produces a bearing 72 toward the launch of the rocket. It will be appreciated that the location of the launch site may be ascertained by positoning additional sensors in a different location to produce a different intersecting bearing.

Referring to FIG. 12, a graph showing a similar method for detecting muzzle blast and bullets passing sensors.

Referring to FIG. 13, another graph showing E field distortion from a 50 caliber bullet is shown.

Referring to FIGS. 14a and 14b, graphs comparing an analytical model and actual data are shown.

Referring to FIG. 15, a graph showing E field distortion when a bullet passed sensors 16 and 20 feet apart at 450 feet is shown.

It will be appreciated that a method of detecting and deterring the bearing to a rocket launch or a muzzle field has been described which is completely passive and which exploits unintended or unavoidable emissions. Those skilled in the art will also appreciate that the sensors used in this method may have very low power and a long life. Sensors which also have low cost and can be made to extremely small dimensions may also be used.

While the present invention has been described in connection with the preferred embodiments of the various figures, it is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

1. A method of detecting a rocket launch or muzzle blast comprising the steps of:
providing a plurality of spaced electrical field sensors; and
measuring distortions of the electrical field at each of said sensors.

2. The method of detecting a rocket launch or muzzle blast of claim 1 wherein dE/dt is measured.

3. The method of detecting a rocket launch or muzzle blast of claim 2 wherein a scatter plot of dE/dt from the rocket launch or muzzle blast is produced, and a bearing to the rocket launch or muzzle blast is ascertained from said scatter plot.

4. The method of claim 1 wherein a rocket launch is detected.

5. The method of claim 1 wherein a muzzle blast is detected.

6. The method of claim 3 wherein a bearing to a rocket launch is ascertained.

7. The method of claim 3 wherein a bearing to a muzzle blast is ascertained.

8. A method of detecting a bearing to a rocket launch or muzzle blast comprising the steps of providing a plurality of spaced electrical field sensors; and measuring dE/dt to produce a scatter plot from which the bearing to the rocket launch or muzzle blast is ascertained.

9. The method of claim 8 wherein a bearing to a rocket launch is ascertained.

10. The method of claim 8 wherein a bearing to a muzzle launch is ascertained.
